(19) United States
(12) Patent Application Publication
(10) Pub. No.: US 2009/0042177 A1
(43) Pub. Date: Feb. 12, 2009

(54) PORTABLE STANDARDIZED CURRICULUM CONTENT DELIVERY SYSTEM AND METHOD

(75) Inventors: Alan D. Davis, Leander, TX (US); Stephen Robert DeVoy, Round Rock, TX (US); Daniel Alan Steinhauser, Austin, TX (US); George David Nincehelser, Round Rock, TX (US)

Correspondence Address: HULSEY IP INTELLECTUAL PROPERTY LAWYERS, P.C., 919 Congress Avenue, Suite 919, AUSTIN, TX, 78701, US

(73) Assignee: IGNITE LEARNING, INC., Austin, TX (US)

(21) Appl. No.: 12/175,311

(22) Filed: Jul. 17, 2008

Related U.S. Application Data
(63) Continuation-in-part of application No. 11/333,767, filed on Jan. 17, 2006.

(51) Int. Cl. G09B 7/00; G09B 7/02

(52) U.S. Cl. 434/350; 434/362

(57) ABSTRACT

A portable standardized curriculum content delivery system presents a menu-driven classroom curriculum in compliance with standardized educational requirements. The disclosed system includes a portable standardized curriculum content delivery system for projecting video, images and playing audio recordings. The portable standardized curriculum content delivery system includes engaging multimedia educational programs for uniquely presenting educational material complying with predetermined educational objectives. The predetermined educational objectives prepare learners for specific standardized achievement goals. Included testing features assist in evaluating student achievement and fulfillment of standardized educational requirements. The system is flexible in use and can be used according to a prescribed usage plan (included), or ad-hoc as needed to assist in teaching.

This application is a continuation-in-part application of and claims the benefit of priority to U.S. Non-Provisional patent application Ser. No. 11/333,767 entitled “MULTIMEDIA STANDARDIZED CURRICULUM EDUCATIONAL SYSTEM AND METHOD OF OPERATION,” by Kenneth Leonard, et al., filed on Jan. 17, 2006, and is incorporated herein by reference in its entirety for all purposes.

### FIELD

The present invention relates generally to educational devices and systems. More specifically, the present invention relates to automated systems for delivering instructional materials to students in a classroom or similar environment. Even more particularly, the disclosed subject matter provides a portable standardized curriculum content delivery system for teaching a broad array of classroom subjects for achieving predetermined educational objectives and discloses various methods for operating the disclosed system.

### DESCRIPTION OF THE RELATED ART

In today's educational system a number of programs require schools to show annual progress in reading, math, social studies, sciences, and other disciplines. These programs base progress of a school's or educational district's education program on testing of the students. With such programs, oftentimes there is the need for students to achieve predefined social and/or emotional intelligence levels. Schools seeking to achieve such educational objectives in a formalized, overt way are truly focusing on producing student results that will prepare the students for real-world situations.

Today's teaching methodologies must include innovative techniques that help lift the stragglers in a classroom. These methodologies need to take into account a wide range of learning styles and other variables in providing different types of instruction that work best for different types of students.

Conventionally, however, text books and related presentation materials have been the only means for reaching a wide variety of students. While textbooks have many advantages over less organized collections of instructional materials, they also have many drawbacks. Textbooks are typically designed with organized content, reinforcement examinations and answer keys, bibliographies and follow up materials. These features are intended to work together to assure that educational programs meet standards established by the educational departments and similar organizations. While textbook content in this format may be comprehensive, the delivery of content in this format is not effective for many students. The delivery of this content is linguistically focused and only a portion of learners have a linguistic learning style. It is also a well known fact that many students find textbooks to be boring in nature. In order for any educational program to be successful, it is important to take learning styles into account and find ways to deliver content in a way that is effective for a broad range of students.

Conventional instructional materials serve only a hypothetically average linguistic student. Many teachers typically modify instructional materials to compensate for differences between the teacher's actual students and the hypothetical student. However, such attempts widely vary from teacher to teacher, sometimes with very different and unpredictable results.

A further drawback of conventional instructional materials is the varied instructional techniques associated with the use of such materials. For example, in some instances, a particular teacher's experience with the subject matter being taught may handicap the educational process. Generally speaking, education suffers when a teacher with less experience in a particular subject is required to present the instructional materials when compared to a teacher who has more experience. For example, if a teacher having little formal training in science is required by a school to teach a standardized science curriculum, highly unpredictable and potentially undesirable learning results may arise in his/her students. In addition, a negative learning experience can lead to a negative attitude toward a specific topic.

Conventional instructional materials, such as textbooks, that may include a great deal of textual material are also severely limiting for students who are not linguistic learners. These alternative learning styles include kinesthetic, logical-mathematical, visual-spatial, musical and others. For example, with many visual learners, the greater the degree of visualization possible in exploring or learning a topic, the more learning occurs. Specifically, the more pictures and graphical representations supplied, and the more detail provided in such pictures and graphical representations, the more effective the learning will be. However, the limited number of static pictures or graphical representations contained in typical textbooks, even when augmented by conventional supplemental materials, falls far short of the degree of visualization needed to effectively present instructional materials for many students.

One attempt at solving these and similar problems seeks to provide video-based software tutorial or training systems. Such systems seek to provide a level of flexibility in pulling together information from a variety of sources and providing a system for managing this variety of instructional materials. Such systems seek to make effective use of educational video tapes, laser video disks, VHF and UHF TV, “live” video via camcorders, closed circuit TV, satellite TV, and CATV to augment instructional materials provided by a teacher. These video resources provide improved visualization of the concepts being taught. As a result, the educational process improves to a limited degree. Typically, such resources are prepared by those who fully understand the subject matter presented. These individuals commonly have a good feel for presenting the instructional materials in an understandable way. Thus, the educational process is enhanced.

A significant problem exists with such systems, however, owing principally to there being so many options from which to choose. In addition, for many multimedia environments, complex software and hardware configurations must be mastered by the teachers, many of whom do not possess advanced computer or multimedia system usage skills. As a result, although there may be many options of advanced multimedia instructional materials for teachers to use in supplementing the available text books for different subjects, the reality often arises that teachers seldom use such tools. The reality is that many teachers focus on textbook usage, and students may lose interest in a subject or school in general.

Many existing multimedia environments require significant capital investment. Electronic instructional materials that work seamlessly in those environments without redundant hardware are more attractive from a financial perspective.

Another significant problem exists with intellectual property protection of any electronic instructional materials. Software piracy and other forms of intellectual property theft are common. Effective intellectual property protection is important not only for electronic educational content but also for any form of electronic content.

A need exists, therefore, for a more effective method and system for achieving key educational objectives set forth by schools or educational institutions.

A need exists for a system and method for augmenting the conventional textbook learning system. This system must be easy to use by a teacher who may not possess advanced computer or multimedia system usage skills.

Still another need exists for a method and system that, by providing supplemental educational content using a variety of learning modalities, aids in teaching the greatest number of students according to different individual learning styles.

A further need exists for a content delivery system and method that works with existing multimedia environments without redundant hardware.

A further need exists for a secure content delivery system and method.

### SUMMARY

In satisfying the above-stated needs, the present disclosure provides an automated system for delivering instructional materials to students in a classroom or similar environment. The disclosed subject matter provides a multimedia, standardized-curriculum educational system for teaching a broad array of classroom subjects in achieving predetermined educational objectives and discloses various methods for operating the disclosed system. As such, the present disclosure supports the educational objectives of complying with major educational goals for a school or education system by augmenting the conventional textbook learning system. The disclosed system and method may be easily used by a teacher who may not possess advanced computer skills and facilitates the delivery of supplemental educational content using a variety of learning modalities, thereby teaching the greatest number of students according to different individual learning needs.

According to one aspect of the disclosed subject matter, therefore, there is provided a portable standardized curriculum content delivery system for presenting a menu-driven classroom curriculum in compliance with standardized educational requirements. The disclosed system includes a storage medium with secure pre-programmed content along with an embedded computing device for making the secure pre-programmed content available via a computing device interface. The pre-programmed storage medium includes multimedia educational programs for presenting educational material complying with predetermined educational objectives. The predetermined educational objectives prepare learners for specific standardized achievement testing. The standardized achievement testing for which the learner is prepared assures achievement by the learners in satisfying said standardized educational requirements.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 illustrates an initial screen for using the preset multimedia curriculum in a social sciences application of the disclosed subject matter;

FIGS. 2 through 11 show varying aspects of the preset multimedia curriculum in a social sciences application of the disclosed subject matter;

FIGS. 12 through 15 present features of a preset multimedia curriculum in a science application of the disclosed subject matter;

FIG. 16 shows a view of an embodiment of a portable unit;

FIG. 17 shows a process flow for determining if HASP driver was previously installed;

FIG. 18 shows a process flow for determining if HASP driver was previously installed;

FIG. 19 shows a process flow of waiting for and processing responses to the user choices;

FIG. 20 shows a process flow in the event that the HASP driver was not previously installed;

FIG. 21 shows a process flow for a user selection of “Run”;

FIG. 22 shows a process flow for a user selection of “Uninstall”;

FIG. 23 shows a view of an embodiment of a user interface of the HASPEditor program;

FIG. 24 shows a view of an embodiment of a user interface of the HASPEditor program;

FIG. 25 shows a view of an embodiment of a user interface of the HASPEditor program;

FIG. 26 shows a view of an embodiment of a user interface of the HASPEditor program;

FIG. 27 shows a view of the processes and components accessed by the licensing process;

FIG. 28 shows a view of the processes and components accessed by the end user;

FIG. 29 shows an overlapping view of the processes and components illustrated in FIGS. 27 and 28; and

FIG. 30 provides an overview of the architecture and update processes.

### DETAILED DESCRIPTION OF THE SPECIFIC EMBODIMENTS

This disclosure presents a portable standardized curriculum content delivery system and method for presenting to a user and learner a curriculum that permits delivering lessons professionally and comprehensively to support the educational objectives of many different types of learning environments. The present embodiment includes pre-loaded multimedia content that conforms to predetermined learning objectives such as, but not limited to, those of public schools in the areas of natural and social sciences. With the presently disclosed system, a user may simply connect the portable unit to a computer associated with a multimedia presentation system and begin teaching one or more students, as easy as a book may simply be opened and used for teaching. However, the material presented is rich in content and multimedia applications, far richer and far more versatile than conventional textbooks and printer materials.

The portable unit provides an aid to teachers in assuring that students become more interested in the content and participate more in class discussions and activities. Using the portable unit, students may achieve a deeper understanding of the material, and may analyze that information and apply it in new ways. Teachers find that they are able to integrate technology into the curriculum in a meaningful and seamless way, and that the portable unit's wide variety of multimedia content appeals to different individual learning styles and interests.

The portable unit is a flexible teaching tool that can be used and adapted in a number of ways. A teacher may, for example, use the portable unit 30 minutes per week (e.g., 10-15 minutes, 2-3 times per week) to present multimedia courses that are organized into units and topics. As another example, the teacher may use it for most of every period, every day.

The portable unit may provide to a user a complete science pedagogy with a full suite of science courseware for middle school education in conformance with a known set of educational standards, such as the Texas Assessment of Knowledge and Skills (TAKS) and Texas Assessment of Academic Skills (TAAS) tests. The portable unit, therefore, offers a multimedia-rich, online learning environment that provides full coverage of science curriculum as established by the TAKS and TAAS tests. The courses are carefully designed to support the best practices of middle school science instruction, taking into account the developmental characteristics of early adolescence, the great variety of students' learning styles and interests, and teachers' needs for an effective and engaging instructional tool.

The portable unit's science courses may include earth science, life science, and physical science. Because different state or regional educational requirements often differ in the content required by their standards, the portable unit's course materials are easily tailored to meet specific state curriculum needs, including integrated and spiral approaches.

The instructional approach of the portable unit provides for teaching students in the ways they learn best. The science curriculum may include topics such as the effects of science on society for linking classroom content to the larger world; learning by doing for using inquiry-based experiments to develop scientific skills; expectation failures for creating powerful teaching moments from students' own explanations, and flexible implementations for supporting the practical demands of the classroom. The science curriculum, therefore, provides a comprehensive, research-based instruction set that provides the appropriate quantity and quality of instructional materials to effectively teach students. This makes the portable unit a valuable addition to the catalog of instructional tools available to teachers and students.

The standardized science curriculum that the portable unit may support takes a multimedia approach superior to traditional print-based instructional materials. The portable unit includes narrated animations that graphically demonstrate a variety of systems and phenomena, such as why seasons occur and what causes the phases of the moon. Interactive environments that allow students to explore hidden worlds—from the cellular level to the Earth's interior dynamics—give concrete meaning to ideas that would otherwise remain vague and abstract. The portable unit may also include videos of natural events and new technologies that students never see in their daily lives help to bring the world into the classroom. The combination of visual, aural, and interactive materials helps students learn concepts faster and more completely than traditional print-based instructional materials. Portable unit's multimedia courseware also allows teachers to account for diverse learning styles. Concepts are conveyed through song, poetry, video, animation, interactive diagrams, and many other formats. Then, because each concept is presented through multiple media pieces, each emphasizing a different combination of learning styles, portable unit's courseware allows students to find the media piece (or pieces) that speak to how they learn best. Multimedia caters to diverse learning styles much more effectively than traditional print-based instructional materials.

With its full suite of science courseware for middle school, the portable unit offers a multimedia-rich, online learning environment that provides full coverage of science curriculum. The courses are carefully designed to support the best practices of middle school science instruction, taking into account the developmental characteristics of early adolescence, the great variety of students' learning styles and interests, and teachers' needs for an effective and engaging instructional tool.

The portable unit science courses include earth science, life science, and physical science. Because states often differ in the content required by their standards, portable unit course materials are easily tailored to meet specific state curriculum needs, including integrated and spiral approaches.

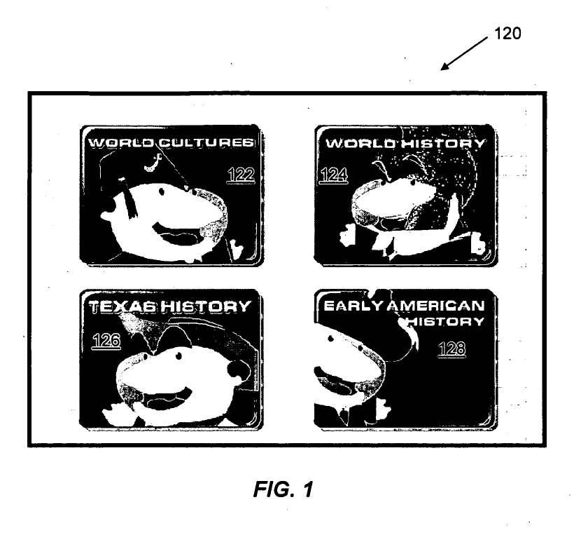

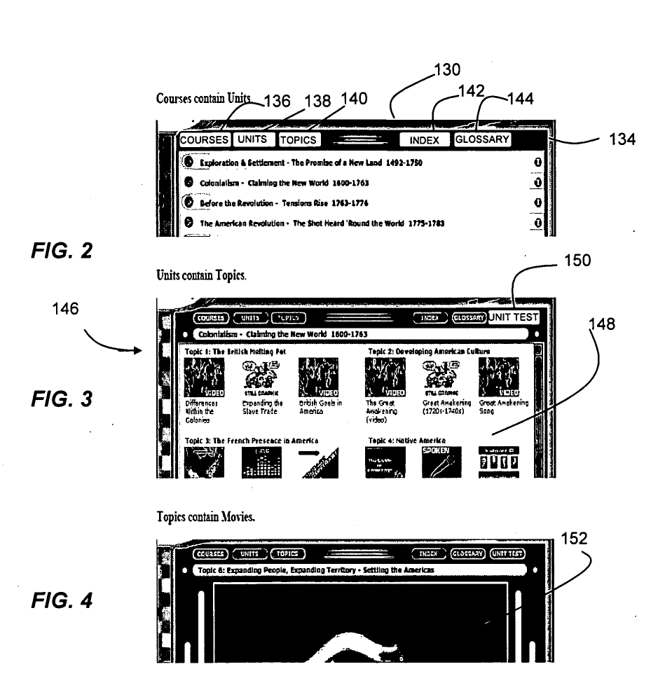

To more completely appreciate the functional features of the disclosed subject matter, FIG. 1 illustrates an initial screen for using the preset multimedia curriculum in an American history application of the disclosed subject matter. For example, the history application of the present embodiment includes a Social Sciences Curriculum menu panel 120 that allows the user to navigate to a World Cultures curriculum 122, a World History curriculum 124, a Texas History curriculum 126, and an Early American History curriculum 128. Each of these curricula includes at least one course as FIGS. 2, 3 and 4 depict. That is, upon selecting Early American History curriculum 128, a curriculum or course screen 130 displays, for example, units listings 132 of study with in the Early American History curriculum 128.

Course screen 130 also displays curriculum navigation button panel 134, which includes selectable buttons, such as COURSE button 136, UNITS button 138, TOPICS button 140, INDEX button 142, and GLOSSARY button 144. Each such button activates a respective screen of functions making available different and respective aspects of a particular standardized multimedia curriculum.

Specific examples of curriculum content may include a Early American History course a unit entitled “Exploration & Settlement—The Promise of a New Land 1492-1750,” topics may include Columbus, Cortés and the Aztecs, Age of Exploration, The Quest for Freedom, Freedom of Religion, and Planting the Seeds of Liberty. In a unit entitled “Jamestown: The First Permanent British Colony” may be taught the topics of Working for a Living, Trading Overseas, Regional Differences, Building Early Society, and Scientific Innovations of the New World. In a unit entitled “Colonialism—Claiming the New World 1600-1763” may be taught the topics of The British Melting Pot, Developing American Culture, The French Presence in America, Native America, A Clash of Cultures, Expanding People-Expanding Territory, King Philip's War (1675-1676), French & Indian War (1754-1763), Colonial Unity in War, Aftermath of War, Continuing Tensions, and England Takes Control.

A unit entitled “Before the Revolution—Tensions Rise 1763-1776” may be presented the topics of Proclamation of 1763, America's Coming of Age, America's Divided Loyalty, England's New Debt, British View of America, British Global Power, Events Leading to the Boston Massacre (Mar. 5, 1770), Events Leading to the Boston Tea Party (Dec. 16, 1773), Events Leading to the Second Continental Congress (May 1775), The Spirit of Revolution—Declaration of Independence (Jul. 4, 1776), and A Brief History of Democracy

A unit entitled “The American Revolution—The Shot Heard 'Round the World 1775-1783” may include topics such as The Beginning of War, Key Battles, Americans Who Rose to Power, British Forces, The Continental Army, Foreign Allies, The Promise of Freedom, The Makings of a New Government, The Price of Victory, Britain After the War, The Impact on France, and The Continual Influence of the Revolution.

A unit entitled “The Birth of the Constitution—Forging a Democracy 1781-1796” may include topics of The Articles of Confederation, An Uprising Among the Poor, Slavery in the Land of the Free, Our Nation's Founders, Federalists vs. Antifederalists, The Constitutional Convention, The Bill of Rights, American Influences, European Influences, Who was George Washington?, Setting a Precedent, and The Key Actions that Made for a Good Presidency.

A unit on “Understanding Our Democracy—The Rights and Responsibilities of the Citizen” may include topics of 1787—Present, Three Branches, States' Rights, The Influences of Factions, The Electoral Process, Constitutional Amendments, How a Bill Becomes a Law, The Individual vs. the State, Limited Freedom of Speech, Sacrificing for the Greater Good, Voting, The Media, Protest and Civil Disobedience, and Early American History.

A unit entitled “America's New Politics and Diplomacy—America Comes of Age 1789-1815” may include topics of The Presidents, their Cabinets, and their Relationships with Congress, The Vice Presidency, Federalism vs. Republicanism, The First Supreme Court, Judiciary Act of 1801, Marbury vs. Madison, France, Jay's Treaty (1794)& Pinckney's Treaty (1795), The Barbary States (1801-1805), Tecumseh and the Battle of Tippecanoe (1811), Prewar Tensions with England, and The War of 1812.

In a unit entitled “The Growth of American Society—Defining America 1795-1815” may be taught the topics of Alexander Hamilton and the National Bank, Barriers to Foreign Trade, Early Industry, The Changing Character of the Nation, Coming to Terms with Liberty, Literature and Religion, Fighting for One's Beliefs, The Alien and Sedition Acts (1798), The Era of Good Feelings, Population Growth, Land Expansion, and Explorers.

A unit entitled “The Age of Jackson—The Impacts of Jacksonian Democracy 1800-1850” may include topics of Andrew Jackson, The Culture He Influenced, The Politics that Surrounded Him, The Cherokee and the Trail of Tears, Official Policy and Rhetoric, Contested Land on the Frontier, The Monroe Doctrine, Florida, Texas, and California, The Mexican War (1846-1848), Wars and Bloodshed in Native America, Living on the Broadening Frontier and The Culture of the Frontier.

Clearly, from the above listing, a user has an extremely robust set of instructional materials providing effective means of conveying standardized curriculum material in, as in the example listing, the social science area of Early American History. With such a robust set of materials, the disclosed subject provides desirable means for accessing and using the multimedia content.

Accordingly, once a user selects a unit within a course, as shown in FIG. 3, for example, unit listing 132, entitled “Colonialism-Claiming the New World 1600-1763,” portable unit shows topics screen 146, see FIG. 4, from which a selection of a topic 148 may occur. For example, upon selecting “Expanding People, Expanding Territory-Settling the Americas,” the user may navigate to the related instructional material. FIG. 3 also shows on curriculum navigation button panel 134 an additional UNIT TEST button 150, which a user may select for displaying an interactive unit test.

Upon selecting such a topic 148, a movie screen 152 of FIG. 4 is shown. At movie screen 152, portable unit 10 displays an interesting instructional movie that is especially developed to teach to standardized content that comports with required curriculum standards and associated learning objectives for such standardized tests as the Texas TAKS and TAAS tests.

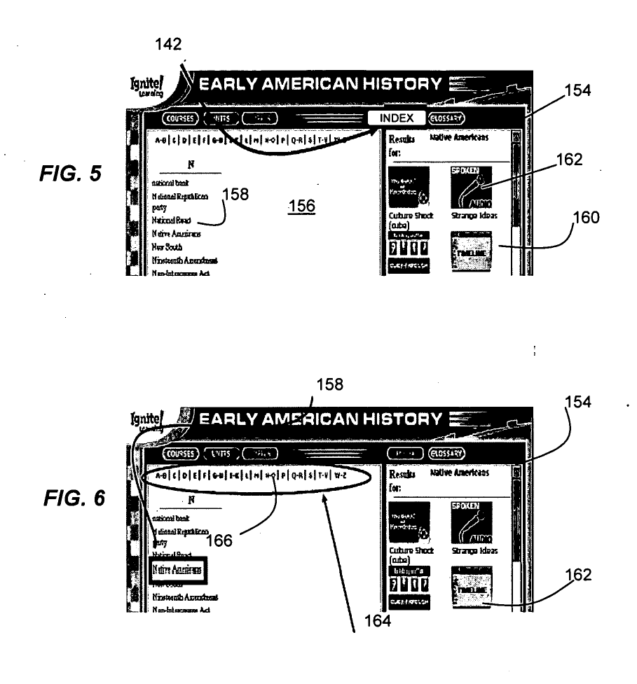

In addition to the rich multimedia content, the portable unit provides with each curriculum a robust multimedia index screen 154 of FIG. 5, which a user may access by selecting INDEX button 150 on curriculum navigation button panel 134 (see, FIG. 2). Use of a curriculum index 156 occurs by selecting a hyperlink activated word 158, for example, “Native Americans.” Upon selecting such hyperlinked word 158, the index screen 154 displays multimedia content panel 160, for example, for presenting to the user available multimedia content 162 to which the user may navigate within the multimedia curriculum. Also, as FIG. 6 shows, alphabet array 164 that allows a user to select a hyperlink activated letter set 164, for example, “N-O” letter set 166, and upon which selection index screen 140 displays the list of hyperlinked activated words 158, for example, “Native Americans,” for which to select multimedia content, and display, as here described.

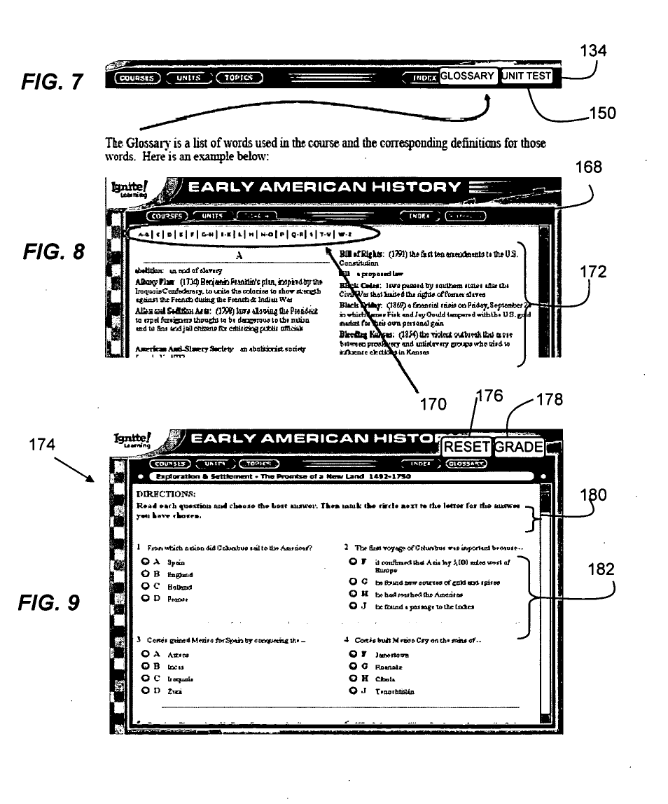

FIG. 7 shows that GLOSSARY button 144 of curriculum navigation button panel 134 may be selected to present glossary screen 168 of FIG. 8. Glossary screen 168 may also include a hyperlink activated letter set 170. Within glossary screen 168 appear definitions and related information 172 for each word or word set that a particular curriculum may include.

FIG. 9 shows test screen 174 to which a user may navigate by selecting UNIT TEST button 150. Test screen 174 includes RESET button 176 and GRADE button 178. Directions 180 provide directions for operation of a test appearing on test screen 174. A test of test screen 174 may take the form of a set of multiple choice questions 182 to which a learner may respond in taking a unit test for a unit within a given topic. The present embodiment of the disclosed subject matter, therefore, provides a wide variety of testing options that may be suitable for a multimedia device such as portable unit. A key difference with many other devices, however, is that this device includes the relevant content of such testing to a standardized curriculum.

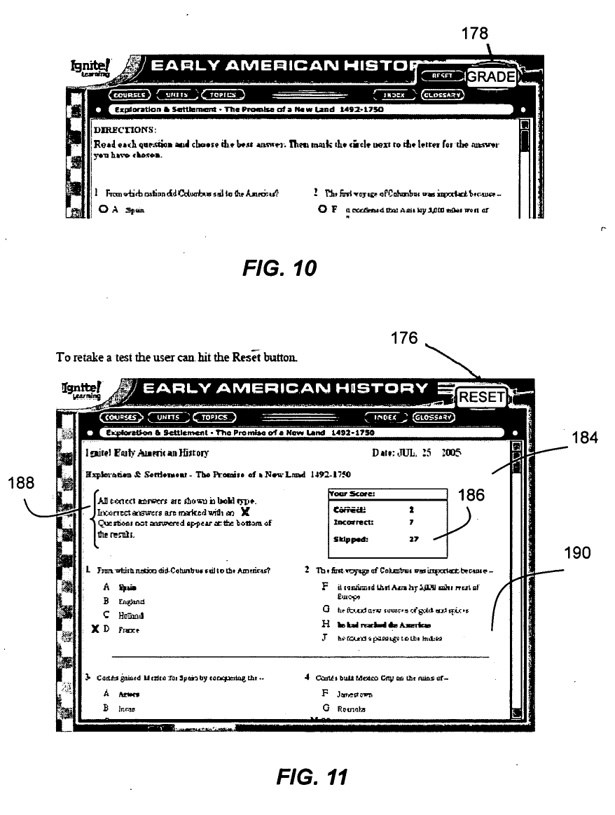

Referring to FIGS. 10 and 11, after taking a test to reinforce the presented curriculum material, a user may select GRADE button 178 to activate a grading function within portable unit 10. In response, graded test screen 184 appears for reporting the results of such a test. Graded test screen 184, for example, includes “Your Score:” template 186 for reporting the test taker(s) score. In addition, graded test screen 184 provides legend 188 for explaining that graded test screen 184 includes graded answers and correct for each of the asked questions. Thus, graded questions 190 include bold type face for the correct multiple choice selections and an “X” to indicate an incorrect answer. There may be many other types of questions and other ways for demonstrating both correct and missed answers.

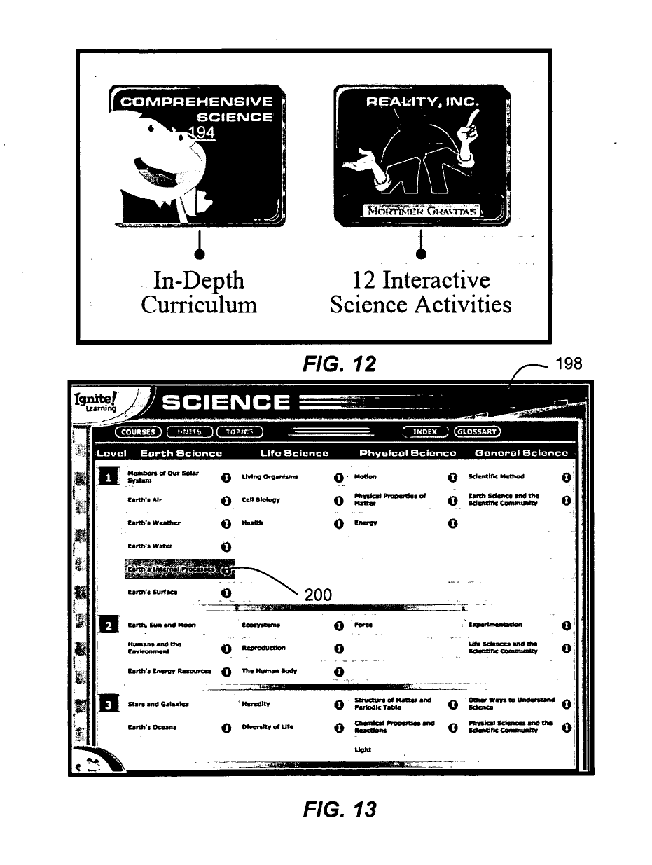

An important aspect of the disclosed subject matter further includes curriculum enhancement content for reinforcing and developing interest in a particular area of study. Accordingly, FIG. 12 shows an example of a science curriculum and activities screen 192 for presenting to a user the option of selecting an in-depth curriculum icon 194 for science teaching or science activities icon 196 for enhancing understanding and interest in the curriculum courses. Upon selecting in-depth curriculum icon 194, science curriculum screen 198 of FIG. 13 appears to the user. Science curriculum screen 198 allows selection from a robust set of interactive, multimedia science courses 200 for teaching science.

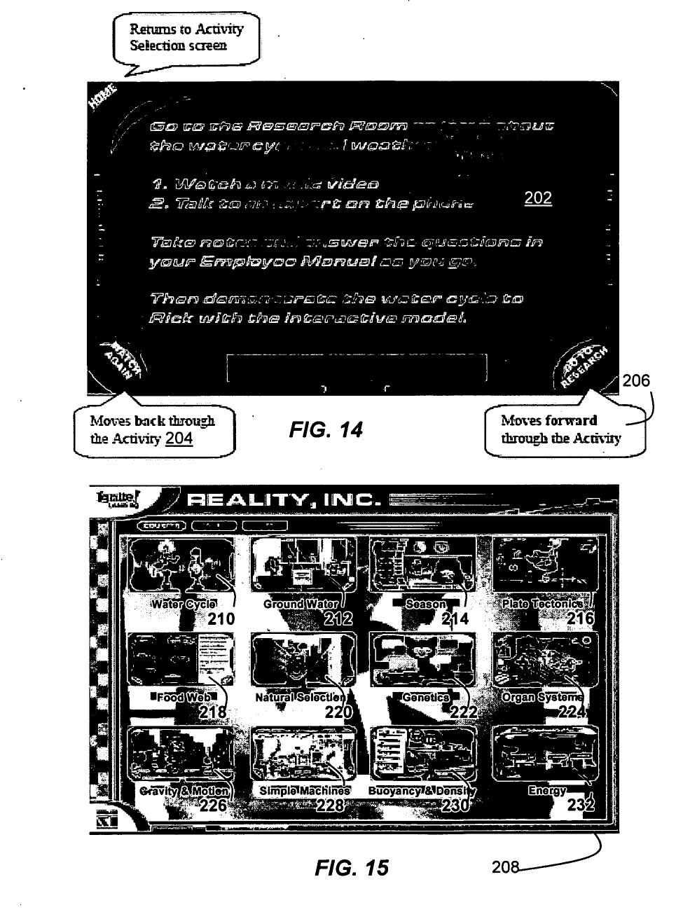

On the other hand, upon selecting science activities icon 196 at screen 192, a highly animated screen 202 as shown in FIG. 14 appears to the user for access the curriculum enhancing content. In the presented scenario, a user navigates to a dark and interesting interview with a seriously, business-type persona called “Mortimer Gravitas,” who is CEO of a company called “Reality, Inc.” After an introduction by Mr. Gravitas, the user may select GO TO RESEARCH icon 204 and navigate to a number of subject enhancing activities. Alternatively, a user may select WATCH AGAIN icon 206 for moving back through a particular activity. Upon selecting GO TO RESEARCH icon 204, REALITY, INC. activities screen 208 as shown in FIG. 15 appears wherein the user may select from the following types of games, movies, or other activities for topic reinforcement wherein the user seeks to perform the associated tasks as here listed:

(a) The Water Cycle-Convince meteorologist Rick Radar of the importance of the water cycle at icon 206;

(b) Groundwater—Help the town of Salty Lick identify what is causing the saltiness in their drinking water at icon 208;

(c) Earth's Seasons—Blow Saffron the Seer's cover by showing what you know about Earth's seasons at icon 210;

(d) Tectonic Plates—Expose Villainess Morbida Destrukt's lies by identifying the true cause of Earth's hidden forces at icon 212;

(e) Ecosystems & Food Webs—Something has caused Reality River to become overrun by algae! Construct a food web and identify the cause at icon 214;

(f) Natural Selection and Antibiotics—Staff the phone lines at Reality Inc. to help the public learn about antibiotics at icon 216;

(g) Genetics and Heredity—Could cats Cosmo and Calliope possibly be the parents of kitten Marzipan Squishyface? Help the owners discover the truth by learning about genetics and heredity at icon 218;

(h) Internal Organ Systems-Mortimer Gravitas lost his sock in his liver and he needs your help finding it. Map the best path through his internal organs at icon 220;

(i) Newton's Laws of Motion and Gravity-Learn Newton's Laws of Motion and Gravity while editing movie scenes for the latest blockbuster thriller, Aliens on Skateboards at icon 222;

(j) Simple Machines—Make a monkey fly while you learn about simple machines at icon 224;

(k) Density and Buoyancy—Help Don't-Sink-It-Ships build a boat that will actually float while learning about density and buoyancy at icon 226;

(l) Energy—Help Team Reality Inc. beat Team Giant Humungacom in everyone's favorite game show, Seven Degrees of Energy Transfer at icon 228.

Many classroom learning environments already have a multimedia presentation station. Many teachers may want to use the standardized content in their classrooms, but a hardware solution such as the “MULTIMEDIA STANDARDIZED CURRICULUM EDUCATIONAL SYSTEM” disclosed in previously filed application Ser. No. 11/333,767 may be undesirable because of the considerable capital investments in the existing multimedia presentation stations. The disclosed subject matter provides for the delivery of standardized curriculum content, as described above, without the need for redundant hardware. Thus, the disclosed subject matter allows for the expansion of the market for the above-described standardized curriculum content.

A standard storage medium, such as a DVD, CD, or floppy disk, etc. does not offer a high level of protection against content piracy. The disclosed subject matter provides for the secure storage of the pre-programmed educational content described above on a storage medium included in a portable unit. The storage medium is connected to a computing device which makes the secure pre-programmed educational content available via a computing device interface.

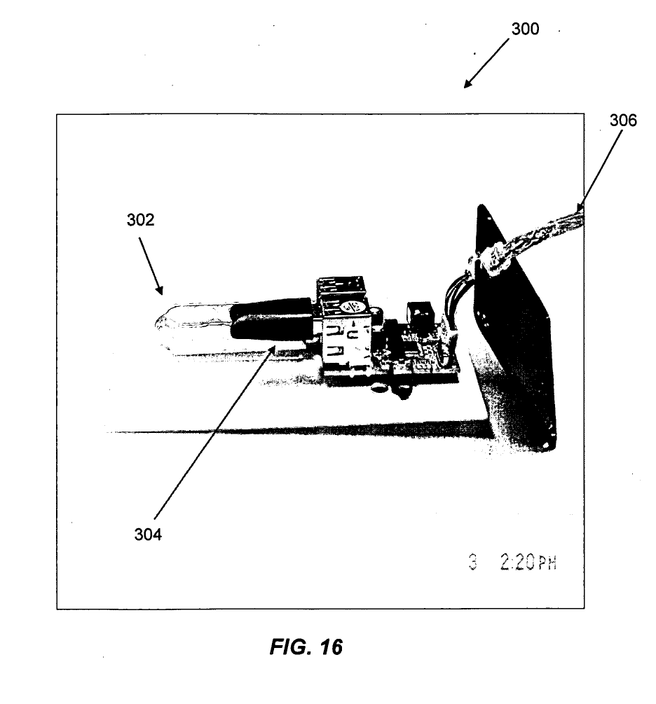

In one embodiment, illustrated in FIG. 16, the portable unit 300 includes a flash memory storage medium 302 with encrypted content, the computing device 304 is a 128 bit AES encryption chip from Aladdin, Inc. of Israel, and the computing device interface 306 is a USB interface.

The portable unit 300 can be plugged into the USB interface on any computer. The content goes along with the portable unit 300. As long as the unit 300 is connected to the computer, the user has access to the secure content. The decryption of the secure content and delivery to the computer via the computing device 304 is transparent to the user.

The disclosed subject matter is unique with regard to several aspects of its design and use. The portable unit 300 is both a hardware and software device. The hardware can be connected to a Windows PC by plugging its USB connector 306 into a PC with Windows XP installed. Upon connection, software contained within the unit 300 is either offered for single click execution or executes automatically, depending upon the system settings of the PC to which it is connected, making the portable unit 300 easy to use, even for those with limited computer skills.

The software is comprised of two applications designed and developed by Applicants and various drivers/support applications provided by Aladdin, Inc., the maker of the computing device 304. Of the applications provided by Applicants, one application is the standardized curriculum content application and the other is responsible for launching the standardized curriculum content application on the Windows PC.

For reasons of digital rights protection, the standardized curriculum content application and its associated media are encrypted on the storage medium 302. Decryption is provided by Aladdin's HASP product. In order to use Aladdin's HASP decryption functionality, a driver which identifies a subcomponent of the portable unit 300's hardware must be installed on the user's Windows PC.

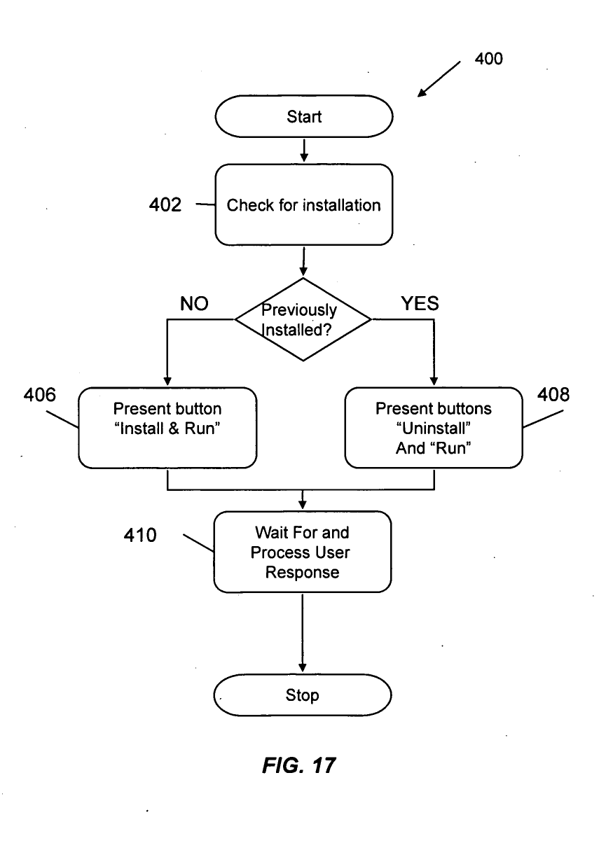

The process flow 400 shown in FIG. 17 begins with the launch software inspecting the connected Windows PC to determine whether or not it has previously installed this HASP driver. In step 402, the launch software determines if Aladdin's HASP driver is already installed on the machine. If Aladdin's HASP driver has not previously been installed on the machine, the launch software offers the option 406 to automatically install this driver and run the standardized curriculum content application. If the HASP driver has previously been installed, the launch software offers the options 408 to launch the standardized curriculum content application or to uninstall the driver.

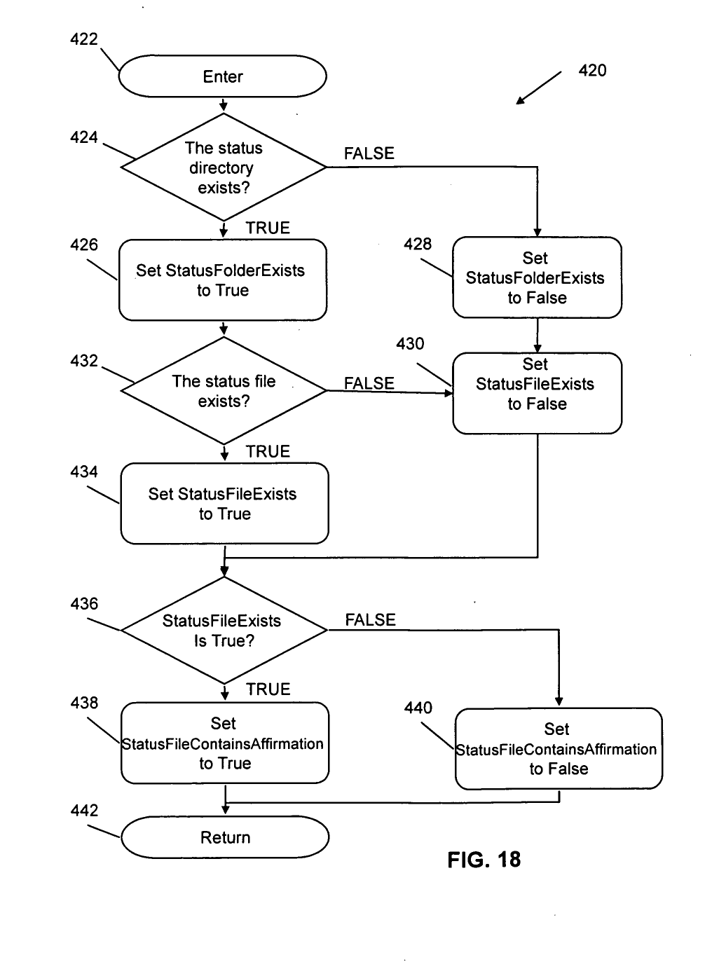

If the user chooses the option 406 to install and run, the HASP driver is installed using Aladdin's program haspdinst.exe. The launch software creates a special directory on the connected Windows PC to store a file specifying the installation status, waits for haspdinst.exe to finish, and then launches the standardized curriculum content application. If the user chooses only to run in option 408, standardized curriculum content is launched. If the user chooses to uninstall in option 408, Aladdin's program haspdinst.exe is run with an option indicating that the driver should be uninstalled. Step 410 shows that the launch software waits for and processes the user response (see FIG. 18 below).

The following FIGUREs outline pseudo-code of the steps described in FIG. 17.

FIG. 18 outlines pseudo-code process flow 420 of checking the Windows PC to determine whether or not it has previously installed the HASP driver, corresponding to step 402 of FIG. 17. Beginning at 422, the program checks to see if the status directory exists 424. If it does (true), the variable StatusFolderExists is set to true 426; if not (false), then StatusFolderExists is set to false 428 and StatusFileExists is set to false 430. The program next checks to see if the status file exists 432. If it does (true), the variable StatusFileExists is set to true 434; if not (false), StatusFileExists is set to false 430. The program again checks to see is the status file exists 436. If it does (true), the variable StatusFileContainsAffirmation is set to true 438; if not (false), StatusFileContainsAffirmation is set to false 440, then a return 442.

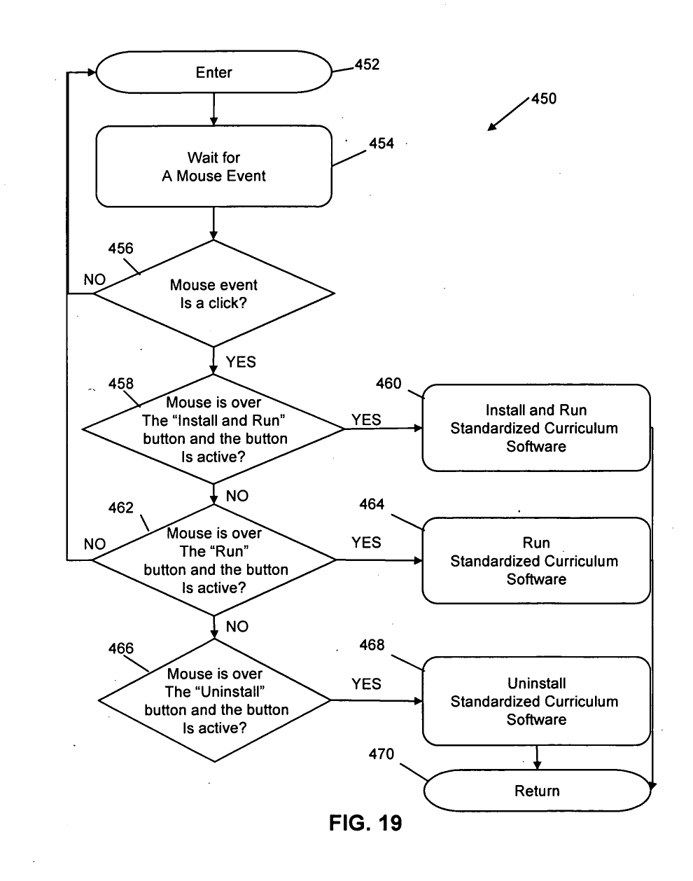

FIG. 19 outlines pseudo-code process flow 450 of waiting for and processing responses to the user choices, corresponding to step 410 of FIG. 17. Beginning at 452, the program waits for a mouse event 454. If mouse event is a click 456, the program determines if the mouse is over the “Install and Run” button, and the button is active 458; if mouse event is not a click, then the program waits for a mouse event 454. If the mouse is over the “Install and Run” button, and the button is active 458, then the program proceeds to install and run the standardized curriculum software 460. If the mouse is over the “Run” button, and the button is active 462, then the program runs the standardized curriculum software 464. If the mouse is over the “Uninstall” button, and the button is active 466, then the program uninstalls the standardized curriculum software 468, then a return 470.

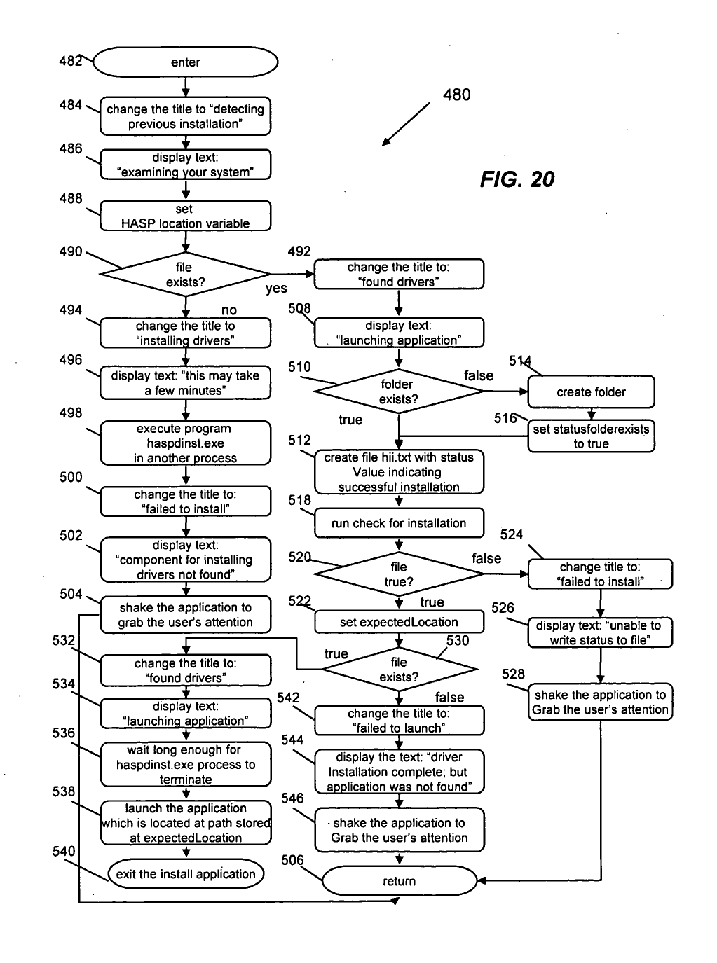

FIG. 20 outlines pseudo-code process flow 480 of the installation process, in the event that the portable unit 300 has not previously installed Aladdin's HASP driver on the machine. Beginning at 482, the program displays a title of “Detecting Previous Installation” 484 displaying text of “MicroCOW is examining your system” 486. The program then sets location variable expectedLocationOfHASPInstallApp to “1\2\3\4\system\haspdinst.exe” 488. Next it determines if the file expectedLocationOfHASP exists 490. If it does (true), the title is changed to “Found MicroCOW Drivers . . . ” 492; if not (false), the title is changed to “Installing MicroDOW Drivers . . . ” 494, then text of “This may take a few minutes” 496. The haspdinst.exe program is then executed in another process 498, with title changed to “Failed to Install” 500, displaying text of “Component for installing drivers not found” 502, and the program shaking the application to grab the user's attention 504, then a return 506. Referring back to step 492, where the drivers are found, the text of “Launching the MicroCOW” is displayed 508. The program next determines if the status folder exists 510 by checking the variable statusFolderExists. If it does (true), the program creates the file “C:\_ignite\hii.txt” 512, saving into it a status value indicating a successful installation; if it does not (false), the program creates the folder “C:\_ignite” 514, then statusFolderExists is set to true 516, and the program then creates the file “C:\_ignite\hii.txt” 512. The program then runs a check for installation 518, by determining if statusFileContainsAffirmation is true 520. If true, the program sets the variable expectedLocationOfCow to “\IgniteClient.exe” 522; if false, the title is changed to “Failed to Install” 524, displaying text of “Unable to write status to file” 526 and shaking the application to grab the user's attention 528, with a return 506. The program next determines if the file located at expectedLocationOfCow exists 530. If it does (true), then the title is changed to “Found MicroCow Drivers” 532, displaying text of “Launching the MicroCow. This may take several seconds” 534. The program waits long enough for the haspdinst.exe process to terminate 536, then the COW application is launched 538, which is located at path stored in expectedLocationOfCow, and the InstallCow application exits 540. If expectedLocationOfCow does not exist (false), then the title is changed to “Failed to Launch” 542, displaying text of “Installation of drivers is complete. However, the MicroCow application was not found.” 544, then shaking the application to grab the user's attention 546, with a return 506.

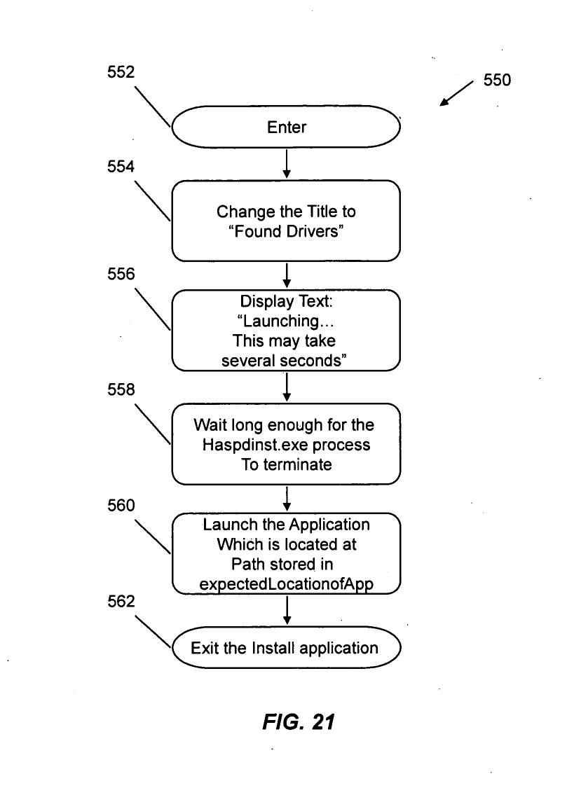

FIG. 21 outlines pseudo-code process flow 550 for a user selection of “Run” (refer to step 462 in FIG. 19). Beginning at 552, the program changes the title to “Found Drivers” 554 and displays text “Launching . . . this make take several seconds” 556. The program waits long enough for the haspdinst.exe process to terminate 558, then launches the MicroCow application which is located at expectedLocationofCow 560. The install application then exits 562.

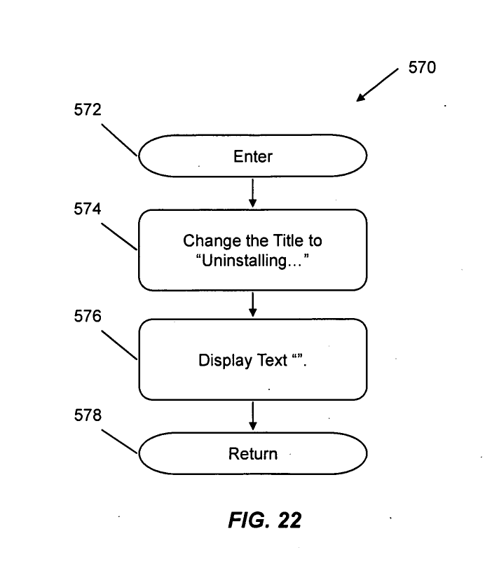

FIG. 22 outlines pseudo-code process flow 570 for a user selection of “Uninstall” (refer to step 466 in FIG. 19). Beginning at 572, the program changes the title to “Uninstalling . . . ” 574 and displays text 576 and returns 578.

Applicant has developed a license enforcement system for the content on the portable unit. This mechanism is the integration of several technologies, both in hardware and software. This system allows the specification and enforcement of four license types: permanent; use count; time limit; and date limit. A permanent license allows the user to use the standardized curriculum content without restriction. A use count license incorporates a counter that permits the standardized curriculum content to be used a specified number of times. Once that specified number of uses is exceeded, the portable unit 300 no longer provides access to the standardized curriculum content. A time limit license monitors the date each time the standardized curriculum content application is executed. If the interval of time between its first use and its current use exceeds the time interval specified for the specific portable unit 300 instance, the portable unit 300 no longer provides access to the standardized curriculum content. A date limit license monitors the date each time the standardized curriculum content application within the portable unit 300 is executed. If the current date exceeds the maximum date specified by Ignite, Inc. for the specific portable unit 300 instance, the portable unit 300 no longer provides access to the standardized curriculum content.

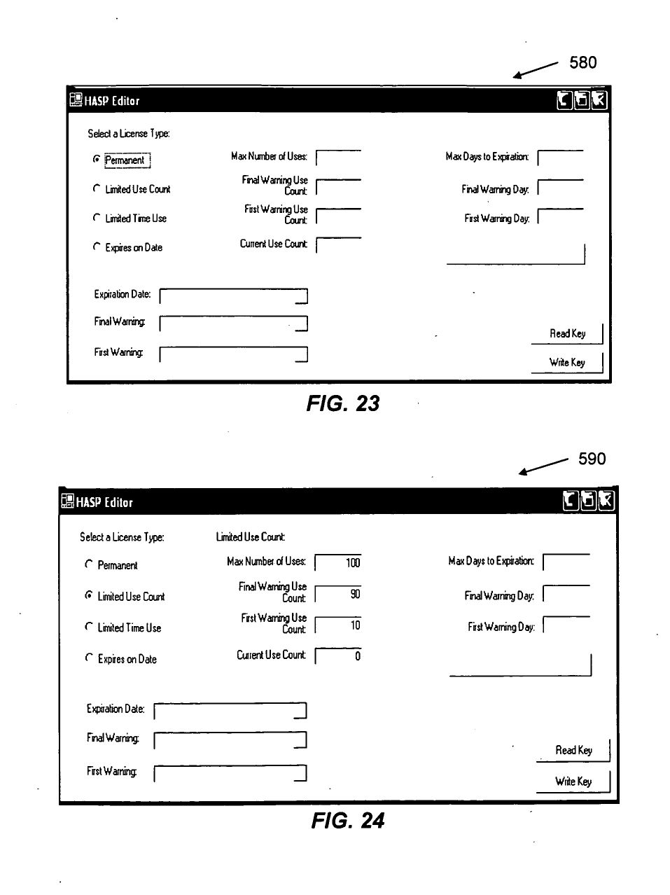

With the exception of the permanent license, all other licenses provide two warnings before ceasing to function. Using the HASPEditor program, a representative of Ignite, Inc. sets the criteria for the first and second warnings. A view 580 of an example of the user interface of the HASPEditor program is shown in FIG. 23. The user interface is divided into four parts, one part for each license type. Additionally, the interface has two buttons: a “Read Key” button and a “Write Key” button.

If a portable unit 300 is attached to the USB port of a computer running the HASPEditor program, the “Read Key” button examines the memory of the key and automatically selects the radio button corresponding to the license type already encoded on the portable unit 300. If the portable unit 300 has not been previously licensed, none of the radio buttons will show themselves as selected immediately after clicking the “Read Key” button.

At any time, the user may select one of the radio buttons listed within the group entitled “Select a License Type”. Upon selecting a radio button, the appropriate license group within the dialog box becomes active. If the license type is “Permanent”, no further data is required and only the “Select a License Type” group box, and its subcomponents, are activated (see above). If the license type is “Limited Use Count”, the group box entitled “Limited Use Count” and its subcomponents is activated. All other license type boxes are deactivated as shown in FIG. 23. In the view 590 shown in FIG. 24, the license limits use of the portable unit 300 currently attached to the USB port to 100 uses. Its current use count is set to 0. A first warning about future inaction will be given upon the tenth use. The second (final warning) will be given after 90 uses. The unit 300 will cease functioning after 100 uses.

Upon specifying the above license, the Ignite, Inc. representative using the HASP Editor would press the write key. Data representing the above constraints would be encoded in the HASP key within the portable unit 300.

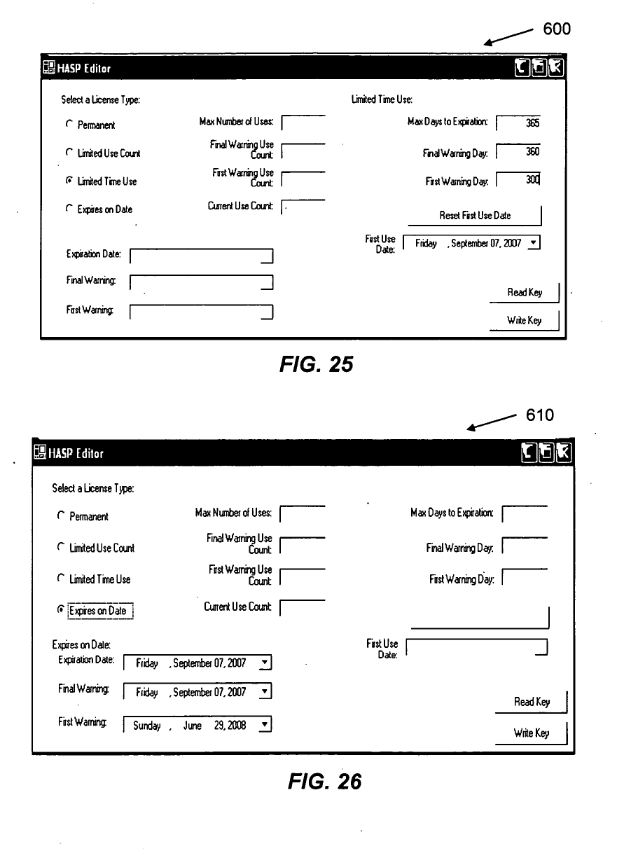

Next we consider the limited time use license as shown in view 600 of FIG. 25. In the above example, the user has specified a limited time use license. Initially, the first use date may be undefined or may be the date the HASP Editor is invoked to edit the HASP key within the portable unit 300. If an undefined first use date is desired, the user should click the “Reset First Use Date” button. If the current date is desired as the first use date, that date should be specified in the “First Use Date” calendar box. The user may enter a maximum number of days use time interval in the top text box within the limited time use group box. This is the number of days until expiration after the first use date. If the user does not specify a first use date, the first use date is the date the COW is first executed by the customer. The first warning date text box specifies the number of days after the first use date at which a warning of future expiration will be presented to the user. The second warning date (last warning) text box specifies the number of days after the first use date at which a warning of future expiration will be presented to the user.

Next we consider date limit license as shown in view 610 of FIG. 26. The date limit license is a license that expires on a specific date. It contains two warning dates, each specified as shown. Once the Ignite, Inc. representative using the HASP Editor has specified the license, she presses the “Write Key” button to encode the licensing data onto the portable unit 300.

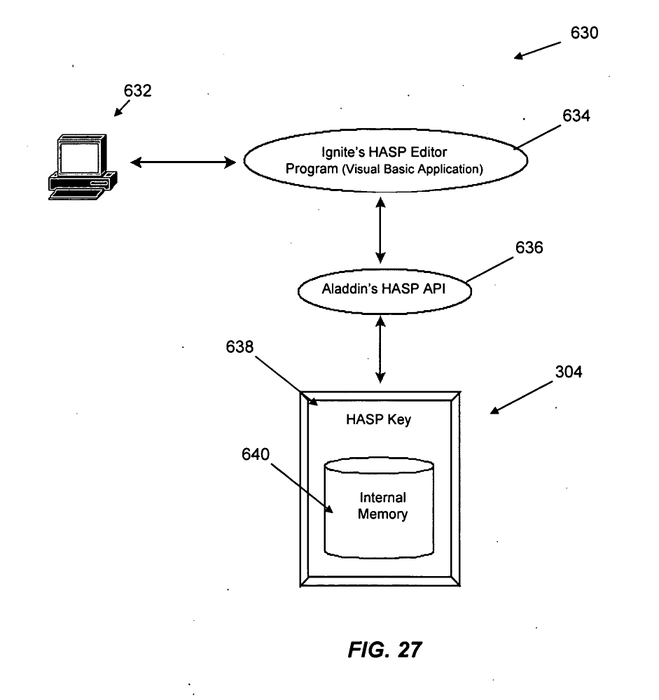

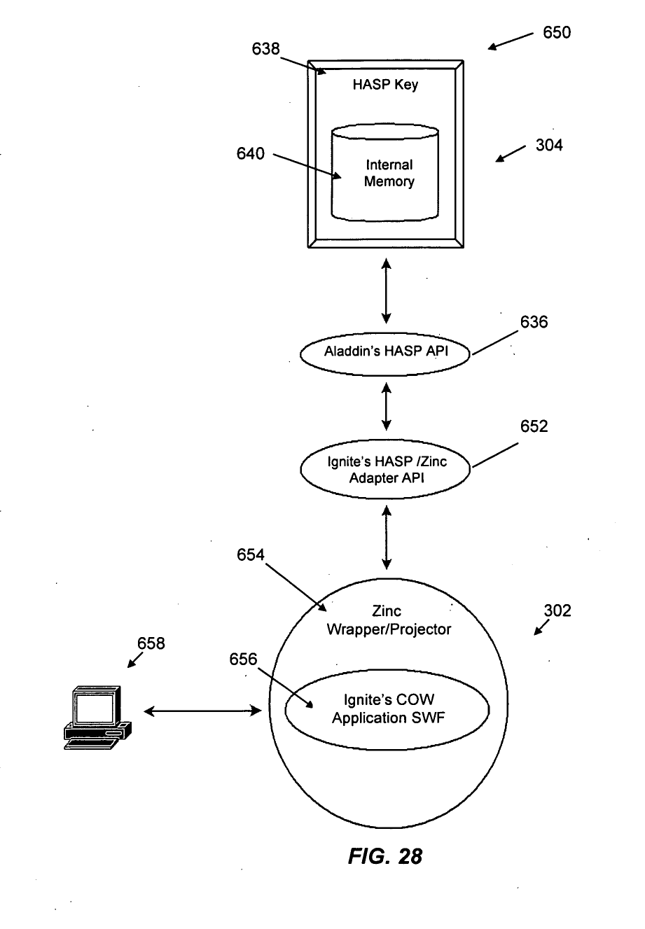

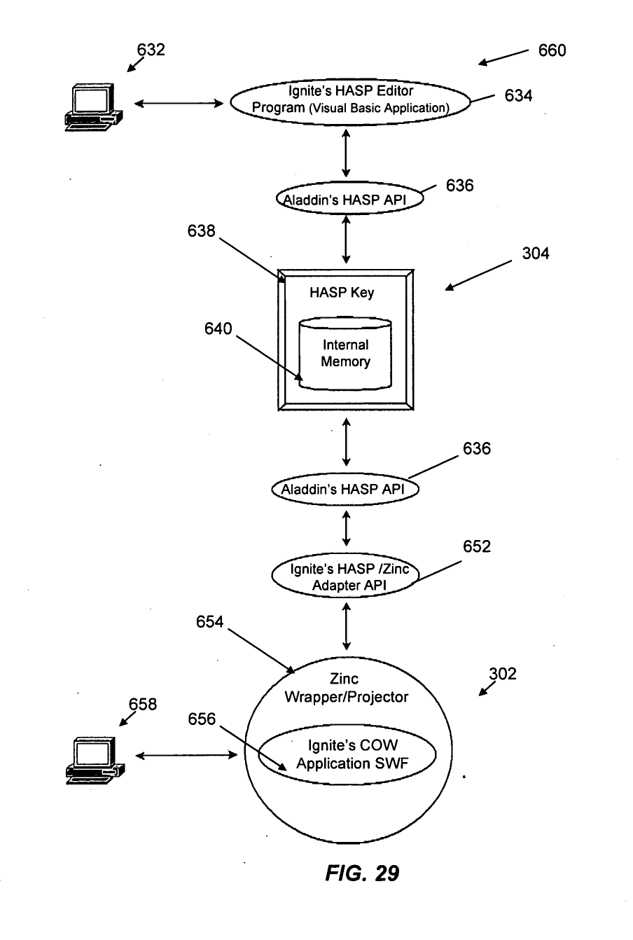

The following FIGUREs illustrate interaction with the portable unit from the perspective of the Ignite, Inc. representative using the HASP Editor software as well as the end user accessing the secure content on the unit with license information encoded using that HASP Editor software. Specifically, FIG. 27 shows a view 630 of the processes/components accessed by the licensing process. FIG. 28 shows a view 640 of the processes/components accessed by the end user. Finally, FIG. 29 shows an overlapping view 660 of the processes/components illustrated in FIGS. 27 and 28.

Referring to view 630 in FIG. 27, an Ignite, Inc. representative uses a computer 632 to interact with the Ignite, Inc.'s HASP Editor program 634 (in one embodiment, a Visual Basic application) which interfaces with Aladdin, Inc.'s HASP API 636 (a DLL from Aladdin, Inc.), allowing for communication with computing device 304 as described above. The computing device 304 contains a HASP key 638 and internal memory 640.

Referring to view 650 in FIG. 28, a second component is a DLL 652 which serves as a bridge between the HASP API 636 and Zinc 654, a product used to convert the Adobe Flash application 656 stored on flash drive 302 (described above) to a Windows Application for use on an end user's computer 658. The HASP/Zinc bridge 652 is a DLL developed by Applicant using the Visual C++ language. A third component is a licensing component within the Adobe Flash application 656, including a set of Adobe Flash classes written in a combination of ActionScript and Zinc's MDM Script.

Aladdin, Inc.'s DLL 636 requires passing arguments by reference. Zinc's API 654 cannot pass arguments to a DLL by reference. The HASP/Zinc bridge 652 passes all arguments by value and maintains, within the DLL, all handles required by the HASP API 636, managing these handles on behalf of Zinc 654. Using this technique, Applicant's standardized curriculum content software, written in ActionScript/Adobe Flash stored on flash drive 302, can communicate with the HASP key 638 using Zinc 654 to communicate with the HASP/Zinc bridge 652 and then using the bridge 652 to communicate with the HASP device 304.

The licensing component reads the data encoded upon the HASP device 304 by the HASP Editor 634 and then either launches, launches and warns, or refuses to launch the standardized curriculum content application based upon this data.

In addition to the embodiments described above for the standardized curriculum content education software from Ignite, Inc., the disclosed subject matter may have applications in many other areas. As noted above, software piracy and other forms of intellectual property theft are common. Effective intellectual property protection is important not only for electronic educational content but also for any form of electronic content.

The disclosed subject matter can be used to effectively manage licenses for any type of electronic content. In the embodiment described above, the standardized curriculum content software is written in ActionScript/Adobe Flash and stored on flash drive 302. Other types of software written in ActionScript/Adobe Flash could readily be substituted for the standardized curriculum education content software. Further, the above technique may be used to allow communication from content software written in other programming languages with Aladdin, Inc.'s HASP API 636. In this way, content can easily be stored on a readily available and inexpensive flash drive with effective license management.

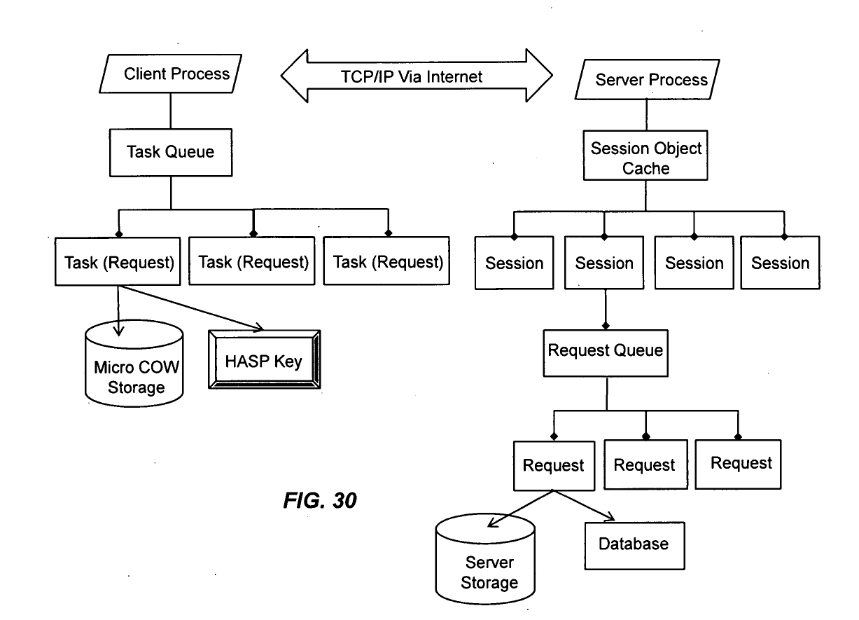

The following section outlines a process of updating the standardized educational content stored on the flash drive 302, using an Internet connection to download updates. FIG. 30 provides an overview of the architecture and update processes described below.

The Update Process (hereafter referred to as the Update Process) has two distinct components: a server running at Ignite, Inc. and a client running on the portable unit 10. In one embodiment, the server process may be available at all times. The client process may be invoked only when the portable unit 10 is not in use for classroom purposes (either by scheduling or by explicit invocation by the teacher or whomever is responsible for the portable unit 10).

The server's architecture includes a directory of COW file structures, a database of information specific to portable unit 10 (e.g., unique identifiers for each unit 10, authorized content, and a user ID and password for the unit 10. Additional information may include a log of each update request and its status), and a process for handling requests from remote units 10.

The client's architecture requires access to disk storage 302 on portable unit 10, access to the HASP key 638, access to the Internet, and an update process that communicates with the server.

In one embodiment, Ruby can be used as the language for implementing the client. Ruby's library includes tools for communicating across the Internet and transferring files across the Internet. Ruby can run from an installation within the unit 10 without installing it on the hard disk of user's computer 658. In one embodiment, Java or Ruby may be used on the server side. Java may be faster than Ruby at run-time. At all times, media content is stored and transferred in encrypted form.

The following section outlines an embodiment of an automatic update process on the client side. Assumptions are that a course's directory structure remains static and file modification date differences are a good indicator of whether a file has been updated.

If an Internet connection is available, a request to log into the update server is sent. The request may include a unique identifier corresponding to the unit 10, a user name, and a password. If the server responds with a successful login, a handle is provided which uniquely identifies this update session and that handle is implicitly provided in all subsequent requests to the server. If the server responds denies access, the top level process exits in failure.

After successfully logging into the server, a request is sent to the server requesting the modification time of the data files for the unit 10. The modification times from the server are compared to the modification times of the files on the unit 10. If the modification time of the courseware-mapping.xml file has changed, a download request for the courseware-mapping.xml file is added to the task queue. If the request failed, the process exits.

For each course, the course's xml file's modification time on the server is compared to the course's modification time on the unit 10. If the modification time on the server is more recent than that on the unit 10, an update course files request is added to the task queue for the course. If there are tasks in the task queue, a temporary directory is created to store any files that will be downloaded. While requests remain in the task queue, the request is processed. A logout request is sent to the server. If the update process has terminated in failure, the temporary directory along with any files in the directory is deleted. If the update process has not terminated in failure, contents of the temporary directory are copied to the unit 10's content directory; the temporary directory along with any files in the directory is then deleted.

The following section outlines the various request types from the portable unit 10. One type of request is a request for modification time of file. To process this request, a request is sent to the server for the modification time of a specific file. If the response is successful, the file modification time is returned. If the response is not successful, a failure to download request is added to the front of the task queue and a message indicating the cause of failure is associated with it.

Another type of request is a request to download courseware-mapping file. To process this request, a request is sent to the server to download the courseware-mapping file and store it in the data directory of the temporary files directory (see above). If this download fails, a failure to download request is added to the front of the task queue and a message is associated with it indicating the cause of failure.

Another type of request is a request to download a course's xml file. To process this request, a request is sent to the server to download the course's xml file and store it in the data directory of the temporary files directory (see above). If this file download fails, a failure to download request is added to the front of the task queue and a message indicating the cause of failure is associated with it. If the course's xml file is successfully downloaded, a modified media list (see below) is created and a download media request for each modified file is added to the task queue. Next, a new media list (see below) is created and a download media request is added for each new file to the task queue.

Another type of request is a request to download a media file. To process this request, a request is sent to the server to download the media file and store it in the appropriate media directory of the temporary files directory. If this file download fails, a failure to download request is added to the end of the task queue and a message indicating the cause of failure is associated with it.

Another type of request is a failure to download request. To process this request, if the failure concerns the courseware-mapping file or a course's xml file, a message is sent to the server indicating that the update was a total failure, the name of the file that failed to download, and an identifier unique to the unit 10. The entire update process exits. If the failure concerns a media item, a message is sent to the server indicating that there was a failure to download the specific media item, the name of the file that failed to download, and an identifier unique to the unit 10. The update process does not exit.

The following section outlines an embodiment of an automatic update process on the server side. Assumptions are that the server has access to a directory containing the encrypted data and/or media files of the secured content to be downloaded.

When a login request arrives, it should include a unique identifier for the unit 10 as well as a user name and a password.

The server validates the login request. If the request is valid, then the server generates a session object, obtains that session object's session id, and replies to the login request with that session id. Additionally, the server logs the successful request. If the request is not valid or if the server cannot schedule the update, for any reason, it logs its failure to permit access and it sends a request denied response to the client.

When a session request arrives, it is mapped to the session object corresponding to the session id. If no session object matches the id, an access denied message is returned to the client.

Each session object has an associated process which handles session requests. Requests of a specific session are enqueued in a session's request queue. The session request remains alive until either it executes a logout request, it times out, or it is killed by the top level process.

The session object process first includes subprocess 1, where a timer object is created and scheduled to interrupt the process when the timeout interval passes. If the timer object is not destroyed before it interrupts the process, upon interrupt the session process ends and the session object is disposed of.

The session object process next includes subprocess 2, where if a request arrives, it is enqueued in the session's request queue. The following are done until killed: while the session's request queue is empty, sleep for a short interval; while the session's request queue is not empty: kill the timer object process; dequeue a request and process the request; create a new timer object process; and log the request and its status (success or failure).

The following section outlines the various server side request types. One type of request is a request for modification time of file. This request is processed by: attempting to find the file on the server; if the file is not present, respond with failure; if the file is present, obtain its modification time and respond with this time.

Another type of request is a request to download courseware-mapping file. This request is processed by: attempting to find the file on the server; if the file is not present, respond with failure; if the file is present, send the file as a response.

Another type of request is a request to download a course's xml file. This request is processed by: attempting to find the file on the server; if the file is not present, respond with failure; if the file is present, send the file as a response.

Another type of request is a request to download a media file. This request is processed by: attempting to find the file on the server; if the file is not present, respond with failure; if the file is present, send the file as a response.

Finally, another type of request is a logout request. This request is processed by: logging the logout request; removing the session object from the top level's cache of session objects; and deleting the session object.

In summary, there is provided a portable standardized curriculum content delivery system for presenting a menu-driven classroom curriculum in compliance with standardized educational requirements. The disclosed system includes a storage medium 302 with secure pre-programmed content along with an embedded computing device 304 for making the secure pre-programmed content available via a computing device interface 306. The pre-programmed storage medium 302 includes multimedia educational programs for presenting educational material complying with predetermined educational objectives. The predetermined educational objectives prepare learners for specific standardized achievement testing. The standardized achievement testing for which the learner is prepared assures achievement by the learners in satisfying said standardized educational requirements.

The present invention has been described above with reference to a preferred embodiment. However, those skilled in the art will recognize that changes and modifications may be made in this preferred embodiment without departing from the scope of the present invention. The processing features and functions described herein can be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A portable standardized curriculum content delivery system for presenting a menu-driven classroom curriculum in compliance with standardized educational requirements, comprising:
a storage medium, said storage medium including secure pre-programmed content comprising engaging multimedia educational programs for presenting educational material complying with predetermined educational objectives, said predetermined educational objectives for preparing learners for geographically specific standardized achievement testing, said standardized achievement testing for determining compliance of said learners in satisfying said standardized educational requirements;
a computing device interface; and
a computing device for making said secure pre-programmed content available via said computing device interface.

2. The portable standardized curriculum content delivery system of claim 1, further comprising a plurality of multimedia educational programs comprising pre-programmed educational content, said pre-programmed educational content associated to facilitate integration of said engaging multimedia educational programs with subject matter associated with regionally-standardized educational requirements.

3. The portable standardized curriculum content delivery system of claim 1, further comprising a plurality of multimedia educational programs comprising pre-programmed educational content, said pre-programmed educational content associated to facilitate integration of said engaging multimedia educational programs with subject matter associated with regionally-standardized educational requirements and comprising a plurality of content navigational functions for facilitating use of said multimedia educational programs through simplified use of a pointing device.

4. The portable standardized curriculum content delivery system of claim 1, further comprising supporting documentation associated to facilitate integration of said engaging multimedia educational programs with subject matter associated with regionally-standardized educational requirements.

5. The portable standardized curriculum content delivery system of claim 1, further comprising a plurality of electronic examinations associated with said engaging multimedia educational programs for reinforcing understanding of subject matter associated with regionally-standardized educational requirements.

6. The portable standardized curriculum content delivery system of claim 1, further comprising a plurality of lesson plans associated with said engaging multimedia educational programs for reinforcing understanding of subject matter associated with regionally-standardized educational requirements.

7. The portable standardized curriculum content delivery system of claim 1, further comprising a plurality of class activities associated with said engaging multimedia educational programs for reinforcing understanding of subject matter associated with regionally-standardized educational requirements.

8. The portable standardized curriculum content delivery system of claim 1, further comprising a plurality of class activities associated with said engaging multimedia educational programs for reinforcing understanding of subject matter associated with regionally-standardized educational requirements, said class activities replicating an operating business environment.

9. A method for presenting a menu-driven classroom curriculum using a portable standardized curriculum content delivery system, said menu-driven classroom curriculum complying with a standardized educational requirements, comprising the steps of:
projecting images and playing audio recordings using a portable standardized curriculum content delivery system;
presenting to an teacher user a simplified control interface facilitating use of said portable standardized curriculum content delivery system comprising a minimal set of control functions; and
presenting educational material complying with predetermined educational objectives using a pre-programmed storage medium comprising engaging multimedia educational programs; and
preparing learners for geographically specific standardized achievement testing in compliance with standardized educational requirements.

10. The method of claim 9, further comprising the step of presenting a plurality of multimedia educational programs comprising pre-programmed educational content, said pre-programmed educational content associated to facilitate integration of said engaging multimedia educational programs with subject matter associated with regionally-standardized educational requirements.

11. The method of claim 9, further comprising the step of presenting a plurality of multimedia educational programs comprising pre-programmed educational content, said pre-programmed educational content associated to facilitate integration of said engaging multimedia educational programs with subject matter associated with regionally-standardized educational requirements and navigating through said multimedia educational programs using a pointing device and a plurality of control icons associated with said multimedia educational programs.

12. The method of claim 9, further comprising the step of using a set of supporting documentation associated to facilitate integration of said engaging multimedia educational programs with subject matter associated with regionally-standardized educational requirements.

13. The method of claim 9, further comprising the step of using a plurality of electronic examinations associated with said engaging multimedia educational programs for reinforcing understanding of subject matter associated with regionally-standardized educational requirements.

14. The method of claim 9, further comprising the step of using a plurality of lesson plans associated with said engaging multimedia educational programs for reinforcing understanding of subject matter associated with regionally-standardized educational requirements.

15. The method of claim 9, further comprising the step of using a plurality of class activities associated with said engaging multimedia educational programs for reinforcing understanding of subject matter associated with regionally-standardized educational requirements.

16. The method of claim 9, further comprising the step of using a plurality of class activities associated with said engaging multimedia educational programs for reinforcing understanding of subject matter associated with regionally-standardized educational requirements, said class activities replicating an operating business environment.
